(19) United States
(12) Patent Application Publication
(10) Pub. No.: US 2023/0387533 A1
(43) Pub. Date: Nov. 30, 2023

(54) Spring Element and Locking Device for Battery Holder

(71) Applicant: Wacker Neuson Produktion GmbH & Co. KG, Reichertshofen (DE)

(72) Inventor: Robert Hartmann, Munich (DE)

(21) Appl. No.: 18/201,407

(22) Filed: May 24, 2023

(30) Foreign Application Priority Data
May 27, 2022 (DE) 10 2022 113 398.2

(51) Int. Cl. H01M 50/247; H01M 50/244; H01M 50/262

(52) U.S. Cl. CPC H01M 50/247; H01M 50/244; H01M 50/262

(57) ABSTRACT

A spring element, usable as a battery holder for a construction machine locking lever, includes a one-piece base body made of an elastic material. The base body has a longitudinal extension and has a first functional area at one first end of the base body, a second functional area at a second end of the base body opposite the first end of the base body, and an expansion area arranged between the first functional area and the second functional area. A first opening is provided in the first functional area for fastening to a first element, and a second opening for attachment to a second element is provided in the second functional area. A first end stop is provided at a end face of the first functional area, and a second end stop is provided at a transition area from the first functional area to the expansion area.

### BACKGROUND OF THE INVENTION

### 1. Field of the Invention

The invention relates to a spring element, in particular, a multifunctional spring element for a battery holder provided on a construction machine with a locking device. The invention additionally relates to battery holder having such a spring element.

### 2. Description of the Related Art

Construction machines, such as vibratory rammers and vibratory plates for soil compaction or floor saws, are increasingly driven by electric drives that draw their electrical energy from electrical energy storage devices (batteries) fastened on the construction machine itself. The advancing development in battery technology has made it possible to build compact batteries with high electrical capacity.

The batteries are generally fastened to the construction machines in a replaceable manner, such that a depleted battery can be replaced by a fresh, charged battery without a long interruption of the working process. For this reason, it is required that the battery is held in a reliable manner in a holder on the construction machine.

It is known to provide a locking device on the battery holder to secure the accommodation of the battery. This locking device can have, for example, a locking element, in particular a locking lever, which is movable between an open and a closed position. In the open position, the battery can be removed and replaced. In the closed position, the battery is reliably secured in the actual battery accommodation, a carrier device, and can be reliably held in the battery holder even during tough construction site operation in which the construction machine is subjected to strong vibrations (for example, in the case of a vibratory rammer or a vibratory plate), such that the electric current can be permanently supplied to the drive motor.

The locking devices are generally secured by pretensioned metallic springs. Metallic springs must sometimes, however, be mounted in a complex manner so that they can remain permanently at their mounting location. They are also vulnerable to manufacturing tolerances.

The insertion of metallic springs may also damage the surface of the parts supporting the springs, which can lead to corrosion in the long term.

In known locking devices, end stops made of metal are also provided, wherein, for example, a metal stop surface on a locking lever abuts against a metal stop surface on the carrier device. The hard stops in the locking device are uncomfortable for the operator. To avoid such hard stops, rubber pads must then be mounted if necessary.

### SUMMARY OF THE INVENTION

The invention is therefore based on the task of specifying a spring element and a battery holder with a locking device with which the disadvantages known from the prior art can be eliminated.

The task is solved by a spring element with a one-piece base body made of an elastic material, which spring element has an extension in a longitudinal direction. The base body comprises: a first functional area at a first end of the base body; a second functional area at a second end of the base body that is opposite the first end of the base body; and an expansion area arranged between the first functional area and the second functional area. A first opening for attachment to one first element is provided in the first functional area, and a second opening for attachment to a second element is provided in the second functional area. A first end stop is provided at the one end face of the first functional area; and a second end stop is provided at a transition area of the first functional area to the expansion area. The spring element may be used for a battery holder, in particular for a locking device for a battery holder.

In so doing, the spring element is made in one piece from an elastic material, for example, rubber, elastomer or plastics. The manufacturing effort for the production of the spring element is thus very low compared to the mechanically much more complex production of metal springs (coil springs or torsion springs) as used in the prior art.

The spring element comprises the one-piece base body which substantially has three areas, the first functional area, the second functional area, and the expansion area located between the other two. The three areas are thus arranged in series or alternatively linearly in a line one after the other and form the longitudinally extending base body. The spring element can thereby exhibit a band-like appearance overall and act similarly to a rubber band.

Openings (first opening, second opening) are provided in each of the two functional areas, at which the base body or alternatively the spring element may be fastened to one respective element (first element, second element). The two openings thereby serve as fastening openings. The two elements are not part of the spring element. The spring element is rather fastened to the two elements with the aid of the two openings. In this way, the two elements can also be joined by means of the spring element. The spring element can thus operatively be arranged between the two elements and can thus function as a spring element with the aid of further mechanical devices that do not form part of the spring element, as will also be explained later.

The expansion area can exhibit a somewhat reduced cross-section compared to the functional areas, so that it can expand well when the spring element is used and can thereby preload in order to fulfill the spring function of the spring element.

The openings serve as fastening openings and can be fastened, for example, to the two elements by means of further elements (screws, hooks, extensions, sheet metal elements, etc.).

In addition, end stops (first end stop, second end stop) are provided on the spring element, which end stops may serve as stops vis-à-vis other elements explained below.

The base body may have a larger cross-section in the area of the first end stop and/or the second end stop than in the areas without end stop. This can mean, for example, that the base body or alternatively the first functional area supporting the end stops is somewhat wider in the area of the end stops and provides a larger end stop surface. In this way, the surface pressure at the end stops can be reduced when a corresponding component of another component strikes the respective end stop.

The base body can have two guide surfaces arranged parallel to each other in the expansion area. The guide surfaces can, for example, be lateral guide surfaces which can be guided by suitable complementary guide surfaces within the device in which the spring element is installed. This can ensure that the spring element cannot break out laterally or that the fastening openings cannot come loose. In addition, surrounding components are thereby protected and centered by the spring element. The centering and the protection of the material are achieved by means of the sides or guide surfaces of the expansion area. In this way, manufacturing tolerances in the surrounding components can also be compensated for, since the elastic spring element can compensate for tolerances to a certain extent.

At the first functional area and/or at the second functional area, between the respective first or second opening and a respective end face of the first functional area, an auxiliary mounting aid area can be provided at the respective end. The mounting aid area can be arranged as a mounting aid in the longitudinal direction outside of the area between the two openings and can, for example, be gripped by an assembler with their hands in order to grasp and stretch the elastic spring element during assembly of the spring element. In this way, the fastening openings or at least one of the fastening openings can, for example, be hung over a hook or extension such that the spring element can be installed very quickly and without assembly tools.

A battery holder also is disclosed. The battery holding includes a carrier device for supporting a battery, and a locking lever for securing or alternatively locking the battery in the carrier device. The locking lever is movable between an open position and a closed position. A spring element is operationally arranged between the locking lever and the carrier device in the manner described above.

The battery holder can be used, in particular, for construction machinery, such as, for example, vibratory tampers or floor cutters. As already explained above, the battery holder is used to hold a battery in the carrier device. The battery can then be secured in its position in the carrier device by the locking lever such that it remains securely in the carrier device, even during working operation. The closed position of the locking lever, in this respect, also represents a locking position.

The carrier device together with the locking lever and the spring element form a locking device for the battery holder.

The spring element or, if necessary, also a plurality of spring elements are arranged between the locking lever and the carrier device. In particular, the spring element acts during a movement of the locking lever. The locking lever can be held in the closed position by the spring element due to a preload of the spring element. In the case of a pivoting or movement of the locking lever from the closed position to the open position, the spring element is stretched such that the locking lever must be moved or alternatively held in the open position by the operator against the effect of the spring force. As a result, the locking lever is always defined in its position. An intermediate position between the open position and the closed position without counter-pressure offered by an operator of the locking lever is not possible, inasmuch as the spring element or the plurality of spring elements would force the locking lever into the closed position.

Upon movement of the locking lever to the open position, the battery can be released and removed from the carrier device.

The spring element may be fastened to the locking lever with its first opening and fastened to the carrier device with its second opening. In so doing, the spring element can bear against the support unit and apply a spring force (constraining force) to the movement of the locking lever in order to force the locking lever to the closed position, as explained above. A portion of the locking lever may penetrate the first opening. For example, the locking lever may consist of a bent sheet metal part over which the spring element with its first opening can be drawn into an intended mounting position.

Alternatively, another suitable fastening option, for example, a hook element, can be formed on the locking lever, to which the first opening of the spring element can be fastened.

At least one recess for holding the spring element in a predetermined functional position can be provided on the locking lever. The recess on the locking lever is suitable to have the first opening be drawn over it and enclose the recess. The recess then serves to secure the spring element on the locking lever in the predetermined functional position, in which the spring element is to securely remain even during operation, for example, when the locking lever is moved. The spring element can then no longer move easily relative to the locking lever.

An extension can be provided on the carrier device, wherein the extension penetrates the second opening of the spring element. The extension can penetrate the second opening of the spring element in a manner similar to a hook and hold the spring element in this way. With a corresponding configuration of the carrier device and of the locking lever, the spring element can then extend between them, in a preloaded state.

The mounting aid area of the spring element may be provided between the second opening and the end face of the second functional area, wherein the mounting aid area is accessible to draw the second opening of the spring element over the extension during an assembly operation.

The assembler can thereby grasp the spring element at the mounting aid area, which is configured, for example, similar to a tab or strap element, and draw the second opening over the extension on the carrier device. The extension then holds the second opening tight like a hook.

Stops may be provided on the carrier device, which stops interact with the end stops of the spring element. The end stops of the spring element serve, in particular, to act in the end positions of the locking lever (open position, closed position) and to provide a buffer between the locking lever and the carrier device without any direct metal-to-metal contact. The stops or alternatively end stops thereby act between the locking lever and the carrier device.

A first stop (opening stop) may be provided on the carrier device, which first stop interacts with the first end stop when the locking lever is in the open position. The locking lever then abuts against the first stop on the carrier device, with part of the spring element acting as a buffer in between.

A second stop (closing stop) can be provided on the carrier device, which second stop interacts with the second end stop when the locking lever is in the closed position. Analogously to the first stop, the second stop acts when the locking lever in the closed position abuts against the carrier device, with part of the spring element acting as a buffer in between.

### BRIEF DESCRIPTION OF THE DRAWINGS

These and further advantages and features of the invention are elucidated in more detail below making use of examples with the aid of the accompanying figures. Wherein:

FIG. 1 shows a spring element according to the invention in perspective;

FIG. 2 shows a partial cutout from a battery holder, with a locking lever in the closed position, however without spring element;

FIG. 3 shows the situation of FIG. 2, however with installed spring element;

FIG. 4 shows the situation of FIG. 3 in perspective;

FIG. 5 shows an enlarged partial view of the battery holder, corresponding to the situation of FIG. 4, however with two spring elements;

FIG. 6 shows a perspective view of a battery holder with two spring elements and one locking lever in the closed position;

FIG. 7 shows a representation analogous to FIG. 3, however with the locking lever in the open position;

FIG. 8 shows another perspective view of the battery holder, with the locking lever in the closed position; and

FIG. 9 shows a perspective view analogous to FIG. 8, however with the locking lever in the open position.

### DETAILED DESCRIPTION

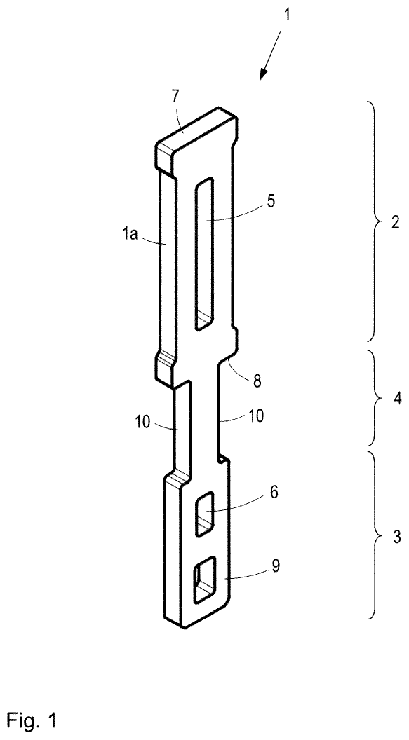

FIG. 1 shows a spring element 1 in perspective, with a one-piece base body 1a made of an elastic material, for example, rubber, elastomer, or an elastic plastics.

The spring element 1 comprises a first functional area 2 and a second functional area 3. An expansion area 4 is provided between the functional areas 2 and 3.

The expansion area 4 has a slightly reduced cross-section compared to the functional areas 2, 3, which can also be understood to be a sidecut.

A first opening 5 is provided in the first functional area 2 and second opening 6 is provided in the second functional area 3. The two openings 5 and 6 are used for fastening to corresponding components of a battery holder, as will be explained later.

A first end stop 7 is provided at the upper end face of the a first functional area 2.

A second end stop 8 is provided at a transition area from the first functional area 2 to the expansion area 4.

A mounting aid 9, in the form of a tab, is provided at the lower end in FIG. 1, between the second opening 6 and the end face of the second functional area 3. The mounting aid 9 can be grasped by an operator with their hands to draw the spring element 1 over appropriate fastening means during assembly.

Lateral guide surfaces 10 are provided on the flanks in expansion area 4, which lateral guide surfaces can be guided through the element in which the spring element 1 is to be installed. In this way, the spring element 1 can compensate for tolerances on the elements involved or bring about a centering of the elements.

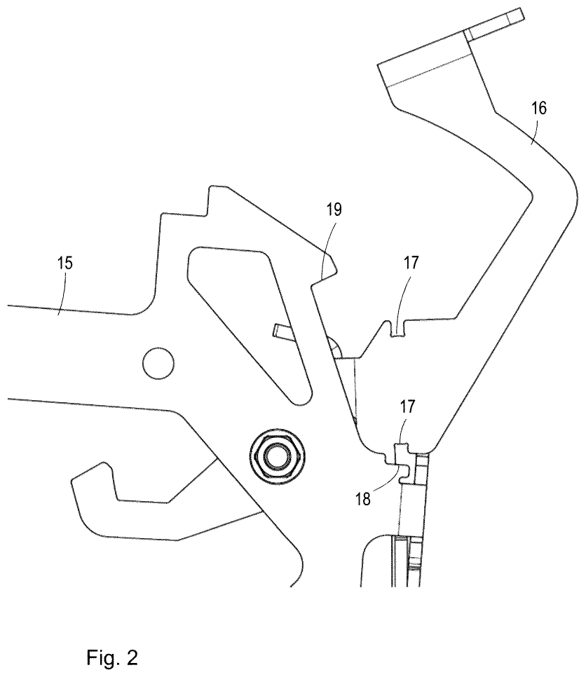

FIG. 2 shows a section of a battery holder in a lateral partial view, which battery holder can be used, for example, in a construction machine.

The battery holder comprises a carrier device 15 and a locking lever 16, which locking lever is pivotably held relative to the carrier device 15. As will be elucidated later, it is also possible that two or more locking levers 16 may be provided to secure the battery, that is not shown, in the carrier device 15.

The locking lever 16 can, in particular, be pivoted relative to the carrier device 15 between an open position and a closed position shown in FIG. 2.

The construction of such a battery holder is known per se and therefore does not need to be further elucidated at this point.

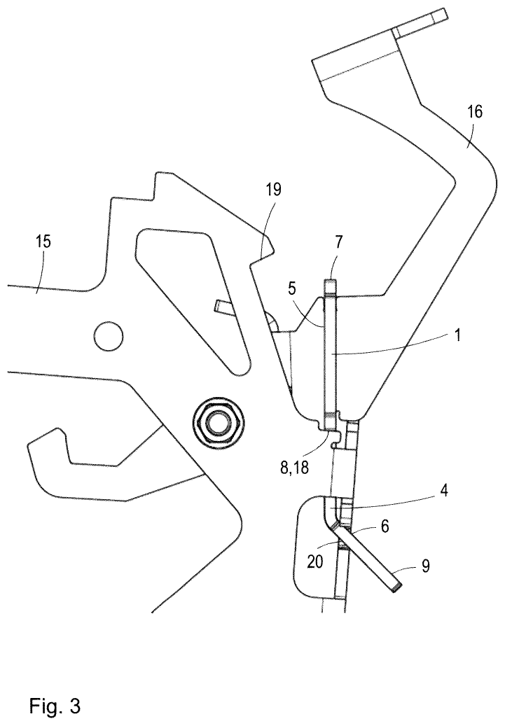

The locking lever 16 is made of a formed (for example, bent several times) sheet metal part and comprises two recesses 17 onto which the first opening 5 of the spring element 1 can be drawn, as shown later in FIG. 3. The distance between the recesses 17 is dimensioned such that it is equal to or greater than the height of the first opening 5 shown in FIG. 1, such that the spring element 1 with the first opening 5 can be held permanently and reliably in the recesses 17 on the locking lever 16.

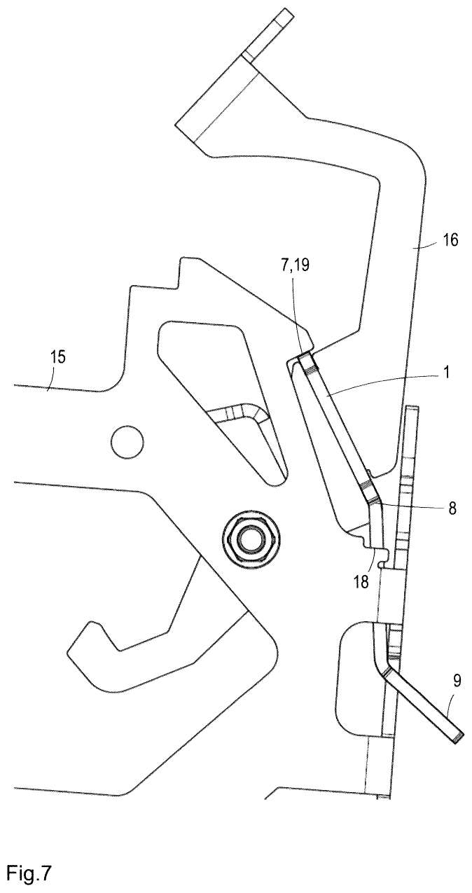

The carrier device 15 can also be manufactured as a complex sheet metal part. It comprises a closing stop 18, against which the locking lever 16 can strike in a closed position shown in FIG. 3. Moreover, the carrier device 15 comprises an opening stop 19 against which the locking lever can strike in its open position (elucidated later with reference to FIG. 7).

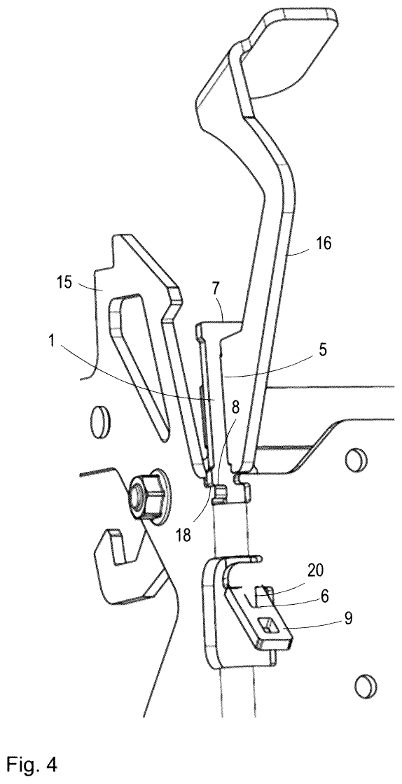

FIG. 3 shows the view of FIG. 2, however in this case with spring element 1 mounted. FIG. 4 shows the same situation in perspective view.

The first opening 5 of the spring element 1 is, in particular, pushed onto the locking lever 16, as already explained above.

Furthermore, the lower, second functional area 3 has been drawn downward with the aid of the mounting aid 9 and the second opening 6 has been drawn over a hook element 20 on the carrier device 15. As a result, an elongation is created in the expansion area 4, which causes the spring element 1 to be preloaded. This causes the locking lever 16 to be held in the closed position shown in FIG. 3.

In this closed position, the second end stop 8 strikes against the closing stop 18 of the carrier device 15. Since the second end stop 8 has rubber-elastic properties as a component of the spring element 1, the impact is soft. Metal-to-metal contact is avoided.

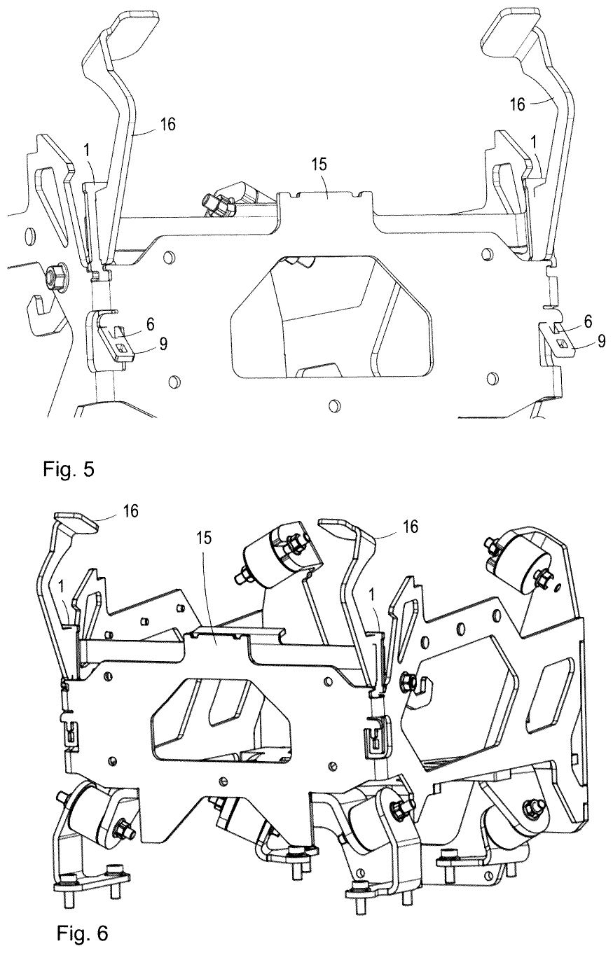

FIG. 5 shows the situation of FIG. 3 and FIG. 4, however in a larger partial view, in which it can also be seen that two locking levers 16 are provided, each of which can be pivoted relative to the carrier device 15.

Lastly, FIG. 6 shows the complete battery holder in perspective view. In the example shown, the battery holder is mounted on a holder in a vibration-decoupled manner by means of intermediately placed rubber buffers. The holder allows the vibration-decoupled battery holder to be installed in a construction machine that is not shown.

FIG. 7 shows a side view that is comparable to that of FIG. 3, however with the locking lever 16 in the open position. To do this, the operator must move the locking lever 16 against the action of the spring element 1. The first stop 7 thereby strikes against the opening stop 19. Due to the spring-elastic material of the spring element 1, the impact is soft. Metal-to-metal contact is avoided.

When the locking lever 16 is moved from the closed position shown in FIG. 2 and FIG. 3 to the open position of FIG. 7, the spring element 1 is stretched so that its spring force increases. The operator must overcome the spring force to move the locking lever 16 to the open position. When the operator releases the locking lever 16, the action of the spring element 1 moves the locking lever 16 back to the closed position (FIG. 2 and FIG. 3).

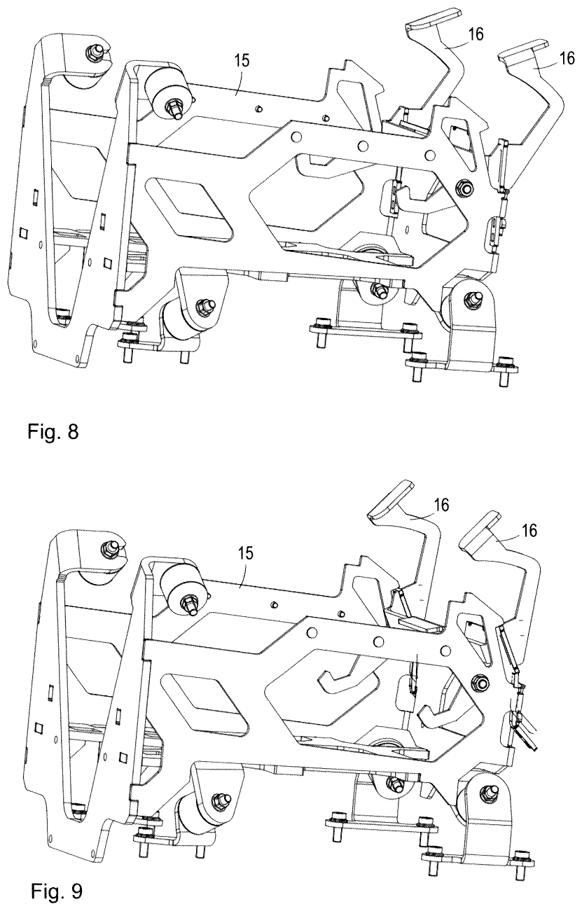

FIG. 8 and FIG. 9 once again show an overview representation of the entire battery holder. In FIG. 8, the two locking levers 16 are in the closed position. In FIG. 9, the two locking levers 16 are in the open position.

The locking levers 16 are each held in a defined end position (closed position) due to the action of the spring elements 1 installed between the carrier device 15 and the locking levers 16.

1. A spring element comprising:
a one-piece base body made of an elastic material and having an extension in a longitudinal direction thereof; wherein the base body comprises:
a first functional area at a first end of the base body;
a second functional area at a second end of the base body, which second end is opposite the first end of the base body;
an expansion area arranged between the first functional area and the second functional area;
wherein
a first opening is provided in the first functional area for fastening to a first element;
a second opening is provided in the second functional area for fastening to a second element;
a first end stop is provided at an end face of the first functional area; and
wherein
a second end stop is provided at a transition area from the first functional area to the expansion area.

2. The spring element according to claim 1, wherein the base body has a larger cross-section in areas of the first end stop and/or of the second end stop than in areas without an end stop.

3. The spring element according to claim 1, wherein the base body comprises first and second guide surfaces arranged parallel to one another in the expansion area.

4. The spring element according to claim 1, wherein a mounting aid area is provided at the first functional area and/or at the second functional area between the respective first opening or second opening and a respective end face of the associated functional area.

5. A battery holder, comprising:
a carrier device for supporting a battery; and
a locking lever for securing the battery in the carrier device;
wherein
the locking lever is movable between an open position and a closed position;
and wherein
a spring element is operatively arranged between the locking lever and the carrier device, wherein the spring element comprises
a one-piece base body made of an elastic material and having an extension in a longitudinal direction thereof; wherein the base body comprises:
a first functional area at a first end of the base body;
a second functional area at a second end of the base body,
which second end is opposite the first end of the base body;
an expansion area arranged between the first functional area and the second functional area;
wherein
a first opening is provided in the first functional area for fastening to a first element;
a second opening is provided in the second functional area for fastening to a second element;
a first end stop is provided at an end face of the first functional area;
and wherein
a second end stop is provided at a transition area from the first functional area to the expansion area.

6. The battery holder according to claim 5, wherein the spring element is fastened with its first opening to the locking lever and with its second opening to the carrier device.

7. The battery holder according to claim 5, wherein the locking lever penetrates the first opening with a partial area.

8. The battery holder according to claim 5, wherein at least one recess is provided on the locking lever, the recess being configured to hold the spring element in a predetermined functional position thereof.

9. The battery holder according to claim 5, wherein
an extension is provided on the carrier device; and wherein
the extension penetrates the second opening of the spring element.

10. The battery holder according to claim 5, wherein
the mounting aid area of the spring element is provided between the second opening and the end face of the second functional area; and wherein
the mounting aid area is accessible for drawing the second opening of the spring element over the extension during a mounting operation.

11. The battery holder according to claim 5, wherein stops are provided on the carrier device, which stops interact with the end stops of the spring element.

12. The battery holder according to claim 5, wherein a first stop is provided on the carrier device, wherein the first stop is configured to interact with the first end stop when the locking lever is in the open position.

13. The battery holder according to claim 5, wherein a second stop is provided on the carrier device, wherein a second stop is configured to interact with the second end stop when the locking lever is in the closed position.
